(19) United States
(12) Patent Application Publication
(10) Pub. No.: US 2026/0352706 A1
(43) Pub. Date: Nov. 5, 2026

(54) ROGUE MASTER STATION DETECTION AND MITIGATION

(71) Applicant: Cisco Technology, Inc., San Jose, CA (US)

(72) Inventors: Priyanka Bansal, Bengaluru (IN); Caldwel Ezhirco, Bengaluru (IN); Praveen Kumar Manickam, Bengaluru (IN); Ashok Kumar Thirugnanasambandam, Tamil Nadu (IN)

(73) Assignee: Cisco Technology, Inc., San Jose, CA (US)

(21) Appl. No.: 19/194,413

(22) Filed: Apr. 30, 2025

(51) Int. Cl. H04L 9/40; H04L 43/026

(52) U.S. Cl. CPC H04L 63/1483; H04L 43/026

(57) ABSTRACT

In one implementation, a device may monitor Distributed Network Protocol traffic sent over a network of a supervisory control and data acquisition system. The device may identify a categorization of a network port associated with the Distributed Network Protocol traffic. The device may determine, based on the categorization of the network port, whether the Distributed Network Protocol traffic is originating from a rogue master station. The device may mitigate activity by the rogue master station.

### TECHNICAL FIELD

The present disclosure relates generally to computer networks, and, more particularly, to rogue master station detection and mitigation.

### BACKGROUND

The Internet of Things, or “IoT” for short, represents an evolution of computer networks that seeks to connect many everyday objects to the Internet. Notably, there has been a recent proliferation of ‘smart’ devices that are Internet-capable such as thermostats, lighting, televisions, cameras, and the like. In many implementations, these devices may also communicate with one another. For example, an IoT motion sensor may communicate with one or more smart lightbulbs, to actuate the lighting in a room when a person enters the room. Vehicles are another class of ‘things’that are being connected via the IoT for purposes of sharing sensor data, implementing self-driving capabilities, monitoring, and the like. The growing complexity of systems that comprise IoT nodes that interact with one another can lead to situations in which one or more nodes affect the safe operating parameter of another node.

In the context of industrial IoT (IIoT) networks, Distributed Network Protocol version 3(DNP3)-based supervisory control and data acquisition (SCADA) systems present unique security challenges, particularly with respect to the threat of rogue master stations capable of injecting malicious commands, disrupting operations, or exfiltrating critical infrastructure data. As IIoT devices are increasingly integrated into smart grids, automated industrial controls, remote monitoring systems, etc., ensuring secure authentication, anomaly detection, and adaptive access control in these networks is of increasing importance. Attempts to mitigate rogue master station attacks by leveraging existing cryptographic techniques ultimately introduce incompatibility, performance degradation, and/or increased complexity issues. Moreover, using firewalls to address rogue master stations attacks is not only very resource and/or CPU intensive, but it is not suitable for mitigating insider attacks.

### BRIEF DESCRIPTION OF THE DRAWINGS

The implementations herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example of an architecture of an industrial communication and/or control network;

FIG. 4 illustrates an example of operations of a system 400 for rogue master station detection and mitigation implemented within an architecture of an industrial network;

FIG. 5 illustrates an example of a packet capture analysis of a DNP3 packet providing the data for rogue master station detection and mitigation; and

FIG. 6 illustrates an example simplified procedure for rogue master station detection and mitigation, in accordance with one or more implementations described herein.

### DESCRIPTION OF EXAMPLE IMPLEMENTATIONS

### Overview

According to one or more implementations of the disclosure, a device may monitor Distributed Network Protocol traffic sent over a network of a supervisory control and data acquisition system. The device may identify a categorization of a network port associated with the Distributed Network Protocol traffic. The device may determine, based on the categorization of the network port, whether the Distributed Network Protocol traffic is originating from a rogue master station. The device may mitigate activity by the rogue master station.

Other implementations are described below, and this overview is not meant to limit the scope of the present disclosure.

### Description

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications (PLC), and others. Other types of networks, such as field area networks (FANs), neighborhood area networks (NANs), personal area networks (PANs), etc. may also make up the components of any given computer network.

In various implementations, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or PLC networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Edge computing, also sometimes referred to as “fog” computing, is a distributed approach of cloud implementation that acts as an intermediate layer from local networks (e.g., IoT networks) to the cloud (e.g., centralized and/or shared resources, as will be understood by those skilled in the art). That is, generally, edge computing entails using devices at the network edge to provide application services, including computation, networking, and storage, to the local nodes in the network, in contrast to cloud-based approaches that rely on remote data centers/cloud environments for the services. To this end, an edge node is a functional node that is deployed close to IoT endpoints to provide computing, storage, and networking resources and services. Multiple edge nodes organized or configured together form an edge compute system, to implement a particular solution. Edge nodes and edge systems can have the same or complementary capabilities, in various implementations. That is, each individual edge node does not have to implement the entire spectrum of capabilities. Instead, the edge capabilities may be distributed across multiple edge nodes and systems, which may collaborate to help each other to provide the desired services. In other words, an edge system can include any number of virtualized services and/or data stores that are spread across the distributed edge nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:
1) Links are generally lossy, such that a Packet Delivery Rate/Ratio (PDR) can dramatically vary due to various sources of interferences, e.g., considerably affecting the bit error rate (BER);
2) Links are generally low bandwidth, such that control plane traffic must generally be bounded and negligible compared to the low rate data traffic;
3) There are a number of use cases that require specifying a set of link and node metrics, some of them being dynamic, thus requiring specific smoothing functions to avoid routing instability, considerably draining bandwidth and energy;
4) Constraint-routing may be required by some applications, e.g., to establish routing paths that will avoid non-encrypted links, nodes running low on energy, etc. ;
5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

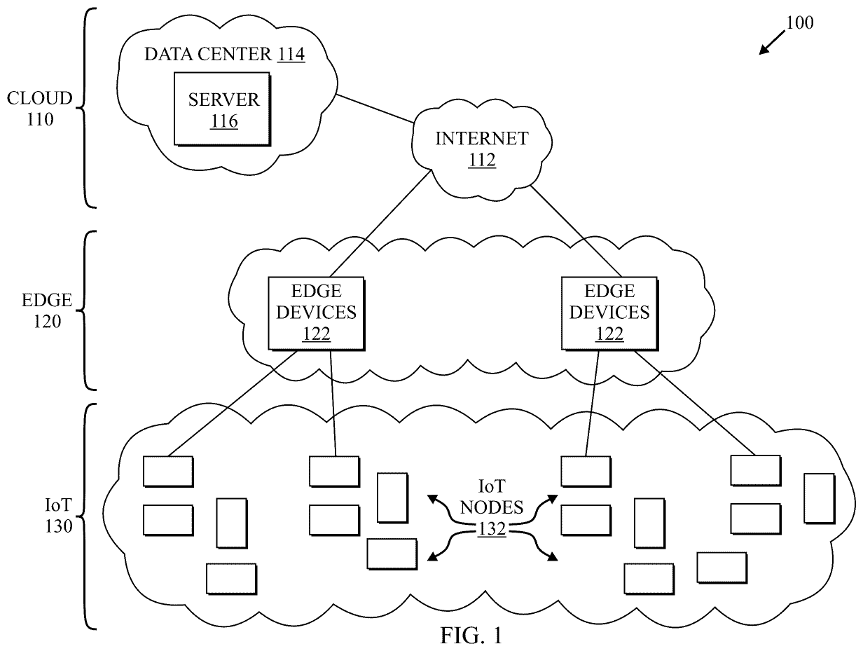

FIG. 1 is a schematic block diagram of an example simplified computer network (computer network 100) illustratively comprising nodes/devices at various levels of the network, interconnected by various methods of communication. For instance, the links may be wired links or shared media (e.g., wireless links, PLC links, etc.) where certain nodes, such as, e.g., routers, sensors, computers, etc., may be in communication with other devices, e.g., based on connectivity, distance, signal strength, current operational status, location, etc.

Specifically, as shown in the example IoT network (e.g., computer network 100), three illustrative layers are shown, namely the cloud layer 110, edge layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the edge layer 120, various edge devices (e.g., edge devices 122) may perform various data processing functions locally, as opposed to datacenter/cloud-based servers or on the endpoint IoT nodes 132 themselves of IoT device layer 130. For example, edge devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, PLC protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the computer network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), PLC protocols, or other shared-media protocols where appropriate. In this context, a protocol consists of a set of rules defining how the nodes interact with each other.

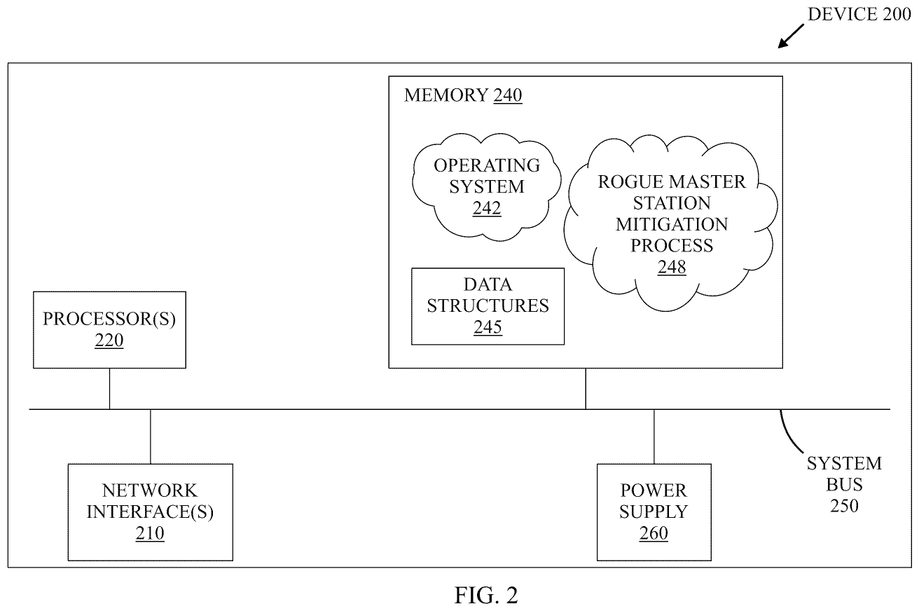

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more network interfaces (e.g., wired, wireless, PLC, etc.) (network interface(s) 210), at least one processor (e.g., processor 220), and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interface(s) 210 may be configured to transmit and/or receive data using a variety of different communication protocols, such as TCP/IP, UDP, etc. Note that the device 200 may have multiple different types of network connections, e.g., wireless and wired/physical connections, and that the view herein is merely for illustration. Also, while the network interface(s) 210 is shown separately from power supply 260, for PLC the network interface(s) 210 may communicate through the power supply 260, or may be an integral component of the power supply. In some specific configurations the PLC signal may be coupled to the power line feeding into the power supply.

The memory 240 comprises a plurality of storage locations that are addressable by the processor 220 and the network interface(s) 210 for storing software programs and data structures associated with the implementations described herein. The processor 220 may comprise hardware elements or hardware logic adapted to execute the software programs and manipulate the data structures 245. An operating system 242, portions of which are typically resident in memory 240 and executed by the processor, functionally organizes the device by, among other things, invoking operations in support of software processes and/or services executing on the device. These software processes/services may comprise an illustrative process such as rogue master station mitigation process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be implemented as modules configured to operate in accordance with the techniques herein (e.g., according to the functionality of a similar process). Further, while the processes have been shown separately, those skilled in the art will appreciate that processes may be routines or modules within other processes.

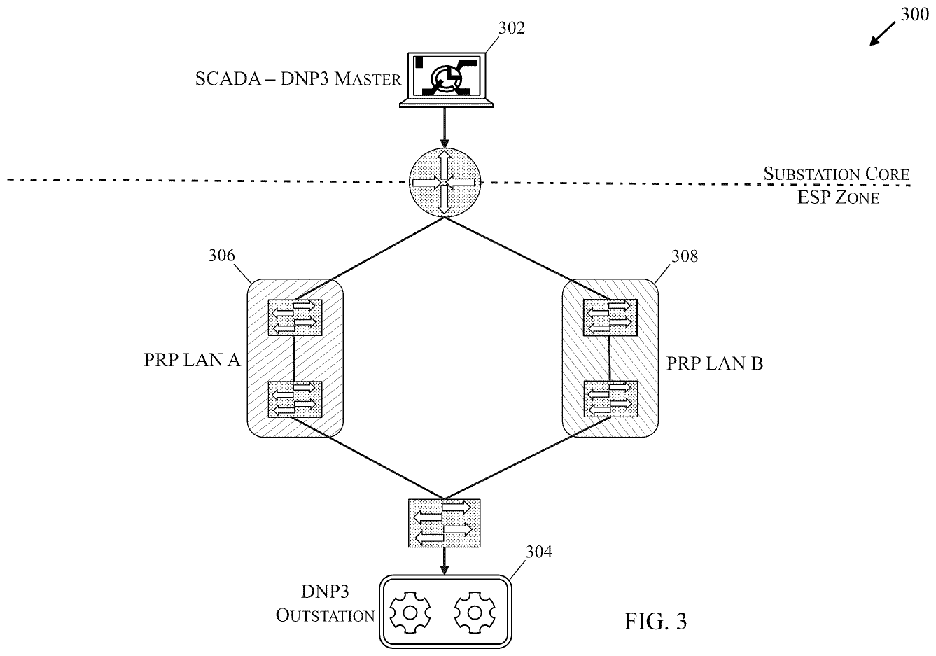

FIG. 3 illustrates an example of an architecture 300 of an industrial communication and/or control network within which a rogue master station mitigation process (e.g., rogue master station mitigation process 248) may be implemented, in accordance with one or more implementations described herein. Architecture 300 may be a SCADA network architecture. Communication within architecture 300 may rely on communication protocols configured to facilitate reliable communications in the adverse environments among components in process automation systems.

For example, architecture 300 may leverage the distribution network protocol version 3 (DNP3). DNP3 may refer to a set of communications protocols used between components in process automation systems for utilities like electric and water companies. DNP3 may be predominately used to communicate information such as sensor readings and control commands between a master station and remote outstations.

By way of example, a master station 302, also known as the control center or master terminal unit (MTU), may be a central coordinator within architecture 300 (e.g., a central coordinator of the DNP3 communication network). Master station 302 may be responsible for initiating communication with outstations. The master station 302 may run on a server or workstation with software designed to communicate with remote devices, collect data, issue control commands, and provide an interface for human operators. In an example implementation, the master station 302 may be positioned within a substation core, responsible for initiating communications and/or issuing control commands to an outstation 304.

An outstation 304, also known as a remote terminal unit (RTU) or field device, may be located at a remote site and may be responsible for interfacing with the physical equipment being monitored or controlled, such as sensors, actuators, and other electrical devices. Outstation 304 may be in an electronic security perimeter (ESP) zone. An outstation 304 can collect data from these devices and send it to the master station 302. Outstation 304 may also receive and execute control commands from the master station 302.

Architecture 300 may include parallel redundant communication paths. For example, the architecture may include one or more parallel LANs (e.g., PRP LAN A 306 and PRP LAN B 308) implementing a parallel redundancy protocol (PRP) to ensure fault tolerance and high availability. The parallel networks may be interconnected by switches.

As noted above, architectures such as architecture 300 are vulnerable to intrusions and/or manipulations by malicious actors via rogue master stations. In the context of SCADA systems and the DNP3 protocol, a “rogue master station” may refer to an unauthorized device that pretends to be a legitimate master station and attempts to communicate with outstations to disrupt operations, steal information, or cause damage. For example, a rogue master could potentially send malicious commands to outstations, which might then carry out those commands, believing them to be legitimate.

Potential risks associated with rogue master stations can include command injection (e.g., a rogue master could send unauthorized control commands to outstations, causing them to operate equipment in an unsafe or unintended manner), data theft (e.g., a rogue master might attempt to retrieve sensitive information from outstations, such as operational data or configuration settings), denial of service (DoS) (e.g., by flooding outstations with requests, a rogue master could overwhelm their processing capabilities, leading to a denial of service), disruption of operations (e.g., by sending incorrect or conflicting commands, a rogue master could disrupt the normal operations of a facility or utility network), etc.

To mitigate the risk of rogue master stations, DNP3 has included the provision of DNP3 Secure Authentication (SA)—which uses cryptographic techniques to validate the identity of the master station and outstations. But there are several issues around the adoption of DNP3 SA like legacy equipment (e.g., many existing installations use older equipment that may not support SAv5 and upgrading these systems can be costly and complex), performance impact (e.g., the additional processing required for encryption and decryption can introduce latency, which can be a concern for time-critical applications), complexity (e.g., implementing SAv5 adds complexity to the system, which can lead to configuration errors and increased maintenance requirements), etc.

Further, while firewalls which can do DNP3 deep packet inspection which may protect from rogue master station, they aren't suitable for an insider attack (e.g., they sit at ESP periphery and cannot capture an attacker plugging in within the ESP zone). Moreover, the firewall-based security approaches are typically very resource and/or CPU intensive.

### Rogue Master Station Detection and Mitigation

In contrast, the techniques described herein introduce a solution for addressing the problem of rogue master stations in a lightweight manner and minimally invasive, without the overhead of full DNP3 SA. These techniques may be leveraged to monitor and filter DNP3 traffic based on a set of trusted parameters. The techniques may act as a security layer within the network infrastructure, such as a switch or router, to validate DNP3 communication.

Illustratively, the techniques described herein may be performed by hardware, software, and/or firmware, such as in accordance with rogue master station mitigation process 248, which may include computer executable instructions executed by the processor 220 (or independent processor of interface(s) 210) to perform functions relating to the techniques described herein.

Specifically, in various implementations, a device may monitor Distributed Network Protocol traffic sent over a network of a supervisory control and data acquisition system. The device may identify a categorization of a network port associated with the Distributed Network Protocol traffic. The device may determine, based on the categorization of the network port, whether the Distributed Network Protocol traffic is originating from a rogue master station. The device may mitigate activity by the rogue master station.

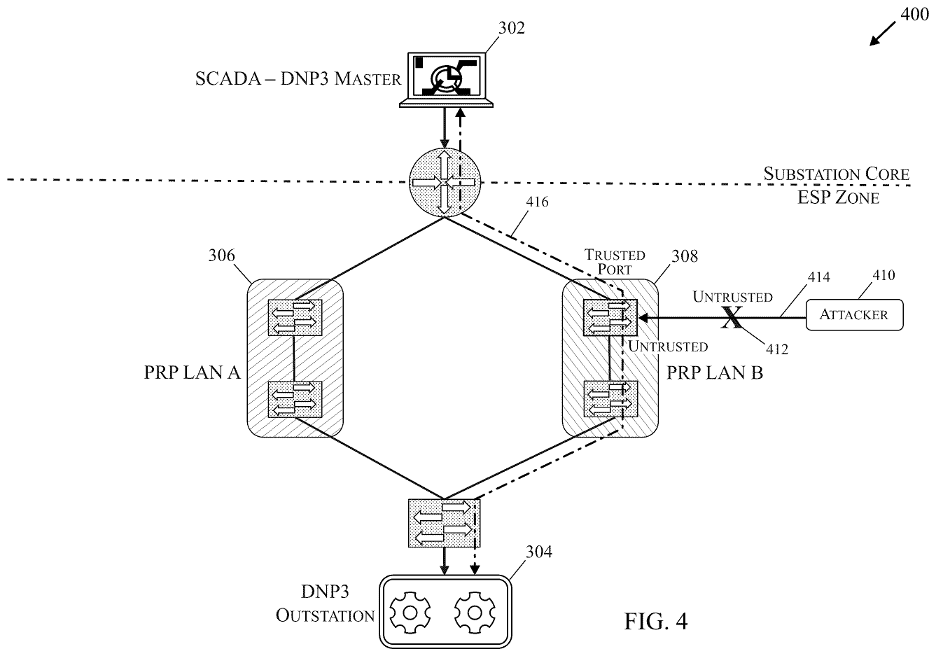

Operationally, FIG. 4 illustrates an example of operations of a system 400 for rogue master station detection and mitigation implemented within an architecture of an industrial network, in accordance with one or more implementations described herein. System 400 may introduce a e security layer that integrates seamlessly with existing network infrastructure, such as switches or routers, to monitor and control network traffic (e.g., DNP3 traffic). System 400 may be operable to distinguish between “trusted” and “untrusted” ports and/or employ a series of checks and balances to ensure that only legitimate master stations (e.g., master station 302) can initiate communication with outstations (e.g., outstation 304), thereby mitigating the threat of rogue actors (e.g., attacker 410).

In various implementations, system 400 may utilize port designation to identify and/or mitigate the risk of rogue master stations and their traffic. For instance, system 400 may categorize and/or leverage categorizations of network ports. For example, network ports connected to verified master stations as “trusted.” Others may be deemed “untrusted.” System 400 may permit communication (e.g., on DNP3 protocols) exclusively through the trusted ports. That is, system 400 may detect that traffic received via a trusted port (e.g., received through a port characterized as trusted) is trusted traffic 416 which is permitted to traverse the network, reach its destination, and/or be acted upon, whereas system 400 may detect that traffic received via an untrusted port (e.g., received through a port characterized as untrusted) is untrusted traffic 414 which triggers a mitigatory response 412 (e.g., traffic is blocked, alerts are generated, traffic is marked as untrusted, traffic is isolated and/or subjected to further scrutiny, etc.).

In addition, system 400 may employ traffic analysis to identify and/or mitigate the risk of rogue master stations and their traffic. For instance, system 400 may conduct and/or leverage continuous monitoring of traffic (e.g., DNP3 traffic) across the network. The monitoring may be used to scrutinize, among other things, the source of the frames (e.g., DNP3 frames). By comparing the traffic and/or its source against pre-established lists of authorized master station identifiers, identifications may be made of trusted traffic/trusted master stations and/or untrusted traffic/untrusted master stations as well as a triggering of the appropriate corresponding permissive or mitigatory operations.

System 400 may also employ a binding table management strategy to identify and/or mitigate the risk of rogue master stations and their traffic. Here, a secure binding table may be generated, maintained, and/or leveraged that correlates trusted master station identifiers (e.g., Internet protocol address (IP address), media access control (MAC address), etc.) with their respective trusted network ports. This table may be securely established during initial system commissioning and/or maintained through a secure management protocol. The table may then be relied upon to supplement the identification of trusted communication channels within the network with the additional parameter of the IP address or MAC address of a trusted master station from which the communication should be received.

Additionally, the system 400 may implement a validation protocol to identify and/or mitigate the risk of rogue master stations and their traffic. For instance, the system 400 may conduct rigorous validation checks on traffic from untrusted ports. This may include a validation operation to validate that a communication (DNP3communication) is actually originating from a rogue master station trying to pose as a legitimate master station. For example, this may be accomplished by analyzing the DNP3 application layer payload of a DNP3 packet to identify direction (DIR) and primary message (PRM) bits within the control field. Utilizing the DNP3 protocol's DIR and PRM bits within the control field, the system 400 may swiftly identify and respond to potential rogue master station activity (e.g., by blocking the traffic or flagging it for further investigation).

System 400 may manage incident responses as well. For example, all DNP3 traffic may be meticulously logged, and the system 400 may be operable to generate immediate alerts upon detection of suspicious activity. These alerts can be integrated with network management and security systems, providing a comprehensive overview of the network's security status and facilitating prompt response to threats. Of course, system 400 may also handle blocking traffic, flagging traffic, sequestering traffic, subjecting traffic to further scrutiny, rerouting traffic, filtering traffic, modifying traffic, blocking a device, blocking a port, etc. in response to its various detections.

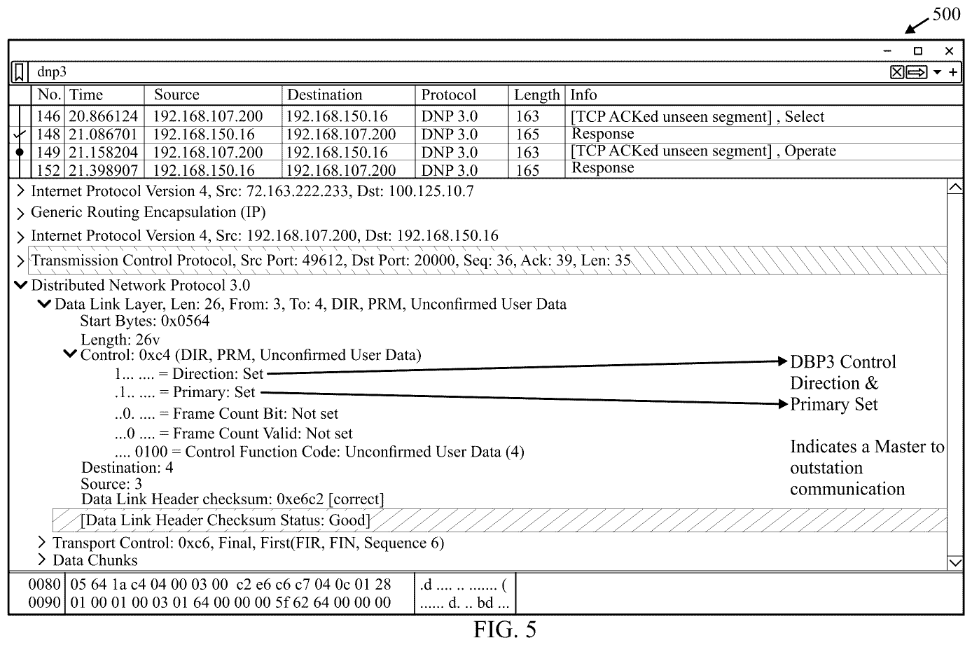

FIG. 5 illustrates an example of a packet capture analysis 500 of a DNP3 packet providing the data leveraged by the system for rogue master station detection and mitigation for completing the above outlined validation protocol, in accordance with one or more implementations described herein. The packet capture analysis 500 includes the values of the DIR and PRM bits in the control fields.

By analyzing the DIR and PRM bits it can be determined whether the packet purports to be from a master station or from an out station (e.g., where the DIR bit indicates the physical direction of the frame with relation to the designated master station with a value of “1” indicating a frame from the designated master station and a value of “0” indicating a frame from a non-master station) and/or whether the packet purports to be a primary message or a response (e.g., where the PRM bit indicates the direction of the frame with relation to the initiating station with a value of “1” indicating a frame from the initiating station and a value of “0” indicating a frame from the responding station).

In this manner, a determination can be made regarding whether the source of the frame is representing itself as having the role of a master station. For instance, traffic may received across a port designated as untrusted, is not associated with a station identifier on a pre-established list of authorized station identifiers, is not associated with an IP or MAC address of a trusted master station on a secure binding table, etc. Yet, that traffic may be representing itself (e.g., determined via the DIR and PRM bit values) as a legitimate master station to outstation command. This may be indicative and/or diagnostic of rogue master station behavior/rogue mater station traffic. Various mitigatory measures such as those outlined above may be initiated as a result.

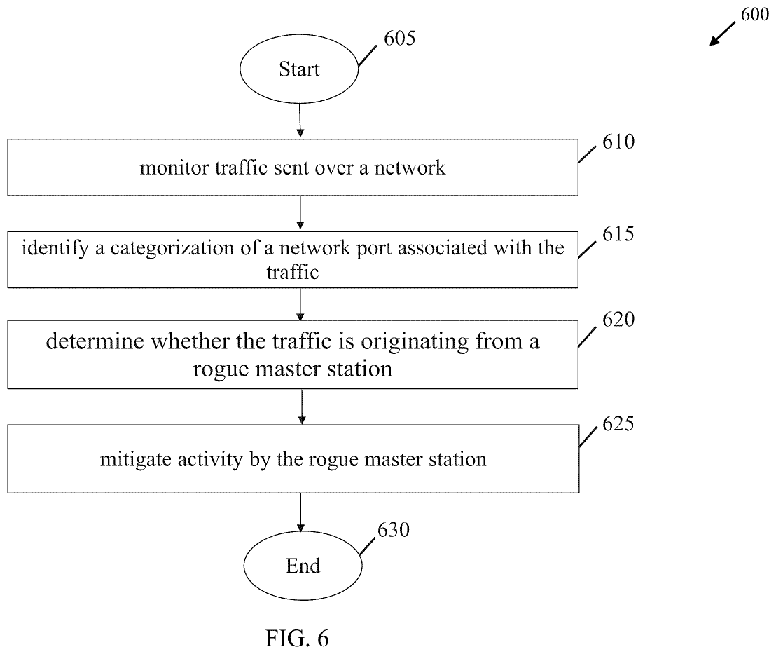

FIG. 6 illustrates an example simplified procedure for rogue master station detection and mitigation, in accordance with one or more implementations described herein. For example, a non-generic, specifically configured device (e.g., device 200) may perform a procedure 600 (e.g., a method) be executing stored instructions (e.g., rogue master station mitigation process 248).

The procedure 600 may start at step 605, and continues to step 610, where, as described in greater detail above, the device (e.g., a controller, processer, etc.) may monitor Distributed Network Protocol traffic sent over a network of a supervisory control and data acquisition system. The device may conduct this monitoring for the purpose of detecting rogue master stations and/or for monitoring and filtering DNP3 traffic based on a set of trusted parameters. The monitoring may be configured to facilitate a security layer within the network infrastructure, such as a switch or router, to validate DNP3 communications.

At step 615, as detailed above, the device may identify a categorization of a network port associated with the Distributed Network Protocol traffic. The categorization of the network port may be based on whether it is known to be connected to a verified master station. For example, the device may assign a trusted categorization to a network port that is known and/or verified to be connected to a known verified master station, whereas it may assign an untrusted categorization to those network ports that are not known and/or verified to be connected to a known verified master station.

In various implementations, the device may permit transmission exclusively of Distributed Network Protocol communications received through networks ports categorized as being known to be connected to a verified master station. That is, traffic may only be permitted when it is received across a trusted network port.

At step 620, the device may determine, based on the categorization of the network port, whether the Distributed Network Protocol traffic is originating from a rogue master station. Determining whether the Distributed Network Protocol traffic is originating from a rogue master station may effectively include identifying a source of the traffic as operating as a rogue master station. In various implementations, the device may determine that the Distributed Network Protocol traffic is originating from a rogue master station based on the categorization of the network port being indicative of it not being connected to a known verified master station. For instance, the network port may be categorized as an untrusted network port.

Additionally, or alternatively, the device may determine that Distributed Network Protocol traffic originates from the rogue master station based on a comparison of a traffic source specified in the Distributed Network Protocol traffic to a list of authorized master station identifiers. For example, continuous monitoring of DNP3 traffic across the network may allow the system to scrutinize the source of DNP3 frames, comparing them against a pre-established list of authorized master station identifiers. Thus, when the traffic is originating from a source not on this list, this may indicate that the source is a rogue master station and that the traffic is originating from a rogue master station.

In further implementations, the device may determine whether the Distributed Network Protocol traffic is originating from the rogue master station based on a comparison of one or more of a traffic source of the Distributed Network Protocol traffic or the categorization of the network port to a secure binding table correlating trusted master station identifiers with their respective network ports. For example, a secure binding table may correlate trusted master station identifiers, such as IP and MAC addresses, with their respective network ports. This table may be securely established during initial system commissioning of the supervisory control and data acquisition system and maintained through a secure management protocol. Thus, if a source identifier and/or network port are not correlated on this list, this may indicate that the source is a rogue master station and that the traffic is originating from a rogue master station.

In other implementations, the device may determine whether the Distributed Network Protocol traffic is originating from the rogue master station based on direction (DIR) and primary (PRM) bit values in a control field of the Distributed Network Protocol traffic. That is, the device may conduct rigorous validation checks on traffic from untrusted ports. Utilizing the DNP3 protocol's DIR and PRM bits within the control field, the device may swiftly identify and respond to potential rogue master station activity.

At step 625, as detailed above, the device may mitigate activity by the rogue master station. Mitigating the activity by the rogue master station may include blocking Distributed Network Protocol traffic associated with the rogue master station and/or flagging the Distributed Network Protocol traffic associated with the rogue master station for further investigation. Additionally, mitigating the activity by the rogue master station may include generating alerts upon determining that the Distributed Network Protocol traffic is originating from the rogue master station.

Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the implementations herein.

The techniques described herein, therefore, provide protection of SCADA systems, offering a practical and minimally invasive solution to a growing security concern. By leveraging existing network infrastructure and focusing on traffic validation rather than content inspection or heavy-duty encryption, the DNP3 Guard provides a scalable, efficient, and effective defense mechanism against the dangers of rogue master stations.

While there have been shown and described illustrative implementations for rogue master station detection and mitigation, it is to be understood that various other adaptations and modifications may be made within the intent and scope of the implementations herein. For example, while specific protocols are used herein for illustrative purposes, other protocols and protocol connectors could be used with the techniques herein, as desired. Further, while the techniques herein are described as being performed by certain locations within a network, the techniques herein could also be performed at other locations, such as at one or more locations fully within the local network (e.g., by the edge device), a remote location (e.g., in the cloud), etc.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

What is claimed is:

1. A method comprising:
monitoring, by a device, Distributed Network Protocol traffic sent over a network of a supervisory control and data acquisition system;
identifying, by the device, a categorization of a network port associated with the Distributed Network Protocol traffic;
determining, by the device and based on the categorization of the network port, whether the Distributed Network Protocol traffic is originating from a rogue master station; and
mitigating, by the device, activity by the rogue master station.

2. The method as in claim 1, wherein the categorization of the network port is based on whether it is known to be connected to a verified master station.

3. The method as in claim 2, further comprising:
permitting transmission exclusively of Distributed Network Protocol communications received through networks ports categorized as being known to be connected to a verified master station.

4. The method as in claim 1, wherein the device determines that the Distributed Network Protocol traffic is originating from the rogue master station based on the categorization of the network port being indicative of it not being connected to a known verified master station.

5. The method as in claim 1, wherein the device determines that the Distributed Network Protocol traffic is originating from the rogue master station based on a comparison of a traffic source specified in the Distributed Network Protocol traffic to a list of authorized master station identifiers.

6. The method as in claim 1, wherein the device determines that the Distributed Network Protocol traffic is originating from the rogue master station based on a comparison of one or more of a traffic source of the Distributed Network Protocol traffic or the categorization of the network port to a secure binding table correlating trusted master station identifiers with their respective network ports.

7. The method as in claim 6, wherein the secure binding table is established during initial commissioning of the supervisory control and data acquisition system and is maintained through a secure management protocol.

8. The method as in claim 1, wherein the device determines that the Distributed Network Protocol traffic is originating from the rogue master station based on direction and primary bit values in a control field of the Distributed Network Protocol traffic.

9. The method as in claim 1, wherein mitigating the activity by the rogue master station comprises:
blocking Distributed Network Protocol traffic associated with the rogue master station or flagging the Distributed Network Protocol traffic associated with the rogue master station for further investigation.

10. The method as in claim 1, wherein mitigating the activity by the rogue master station comprises:
generating alerts upon determining that the Distributed Network Protocol traffic is originating from the rogue master station.

11. An apparatus, comprising:
one or more network interfaces;
a processor coupled to the one or more network interfaces and configured to execute one or more processes; and
a memory configured to store a process that is executable by the processor, the process when executed configured to:
monitor Distributed Network Protocol traffic sent over a network of a supervisory control and data acquisition system;
identify a categorization of a network port associated with the Distributed Network Protocol traffic;
determine, based on the categorization of the network port, whether the Distributed Network Protocol traffic is originating from a rogue master station; and
mitigate activity by the rogue master station.

12. The apparatus as in claim 11, wherein the categorization of the network port is based on whether it is known to be connected to a verified master station.

13. The apparatus as in claim 12, wherein the process when executed is further configured to:
permit transmission exclusively of Distributed Network Protocol communications received through networks ports categorized as being known to be connected to a verified master station.

14. The apparatus as in claim 11, wherein the apparatus determines that the Distributed Network Protocol traffic is originating from the rogue master station based on the categorization of the network port being indicative of it not being connected to a known verified master station.

15. The apparatus as in claim 11, wherein the apparatus determines that the Distributed Network Protocol traffic is originating from the rogue master station based on a comparison of a traffic source specified in the Distributed Network Protocol traffic to a list of authorized master station identifiers.

16. The apparatus as in claim 11, wherein the apparatus determines that the Distributed Network Protocol traffic is originating from the rogue master station based on a comparison of one or more of a traffic source of the Distributed Network Protocol traffic or the categorization of the network port to a secure binding table correlating trusted master station identifiers with their respective network ports.

17. The apparatus as in claim 11, wherein the apparatus determines that the Distributed Network Protocol traffic is originating from the rogue master station based on direction and primary bit values in a control field of the Distributed Network Protocol traffic.

18. The apparatus as in claim 11, wherein the apparatus mitigates the activity by the rogue master station by:
blocking Distributed Network Protocol traffic associated with the rogue master station or flagging the Distributed Network Protocol traffic associated with the rogue master station for further investigation.

19. The apparatus as in claim 11, wherein the apparatus mitigates the activity by the rogue master station by:
generating alerts upon determining that the Distributed Network Protocol traffic is originating from the rogue master station.

20. A tangible, non-transitory, computer-readable medium storing program instructions that cause a controller in a network to execute a process comprising:
monitoring Distributed Network Protocol traffic sent over a network of a supervisory control and data acquisition system;
identifying a categorization of a network port associated with the Distributed Network Protocol traffic;
determining, based on the categorization of the network port, whether the Distributed Network Protocol traffic is originating from a rogue master station; and
mitigating activity by the rogue master station.
